(19) United States
(12) Patent Application Publication
(10) Pub. No.: US 2025/0108299 A1
(43) Pub. Date: Apr. 3, 2025

(54) NON-TRANSITORY RECORDING MEDIUM STORING GAME PROGRAM, GAME PROCESSING METHOD AND GAME DEVICE

(71) Applicant: KOEI TECMO GAMES CO., LTD., Yokohama-shi (JP)

(72) Inventors: Yuishin TAKAFUJI, Kanagawa (JP); Yuki OSHIMA, Kanagawa (JP); Kenichiro YASUDA, Kanagawa (JP)

(21) Appl. No.: 18/895,390

(22) Filed: Sep. 25, 2024

(30) Foreign Application Priority Data
Oct. 2, 2023 (JP) 2023-171564

(51) Int. Cl. A63F 13/537; A63F 13/58

(52) U.S. Cl. CPC A63F 13/537; A63F 13/58

(57) ABSTRACT

A non-transitory recording medium storing a game program that causes a computer to execute a process. The process includes, in a game in which it is possible that a user ascertains a result of a fight, performing the fight in a first manner in a case in which a user is unable to ascertain a course of the fight, and performing the fight in a second manner and with all or part of the first manner in a case in which a user is able to ascertain the course of the fight.

### CROSS-REFERENCE TO RELATED APPLICATION

This application is based on and claims priority under 35 USC 119 from Japanese Patent Application No. 2023-171564, filed on Oct. 2, 2023, the entire disclosure of which is incorporated by reference herein.

### BACKGROUND

### Technical Field

The present disclosure relates to a non-transitory recording medium recorded with a game program, a game processing method, and a game device.

### Related Art

Japanese Patent No. 6827481 describes technology that stops only some players from performing an event in a game that should ordinarily be performed by multiple players together.

### SUMMARY

A non-transitory recording medium recorded with a game program of an aspect of the present disclosure includes a game program that causes a computer to execute a process. The process includes, in a computer game in which it is possible that a user ascertains a result of a fight, performing the fight in a first manner in a case in which a user is unable to ascertain a course of the fight, and performing the fight in a second manner and with all or part of the first manner in a case in which a user is able to ascertain a course of the fight.

### BRIEF DESCRIPTION OF THE DRAWINGS

FIG. 1 is a block diagram illustrating a hardware configuration of a game device;

FIG. 2 is a first block diagram illustrating an example of a functional configuration of a game device;

FIG. 3 is a flowchart illustrating a flow of particular processing;

FIG. 4 is a first display example displayed on a display of a game device;

FIG. 5 is a second display example displayed on a display of a game device;

FIG. 6 is a first explanatory diagram to explain changes in individual physical strength of a friend character FC1;

FIG. 7 is a second block diagram illustrating an example of a functional configuration of a game device;

FIG. 8 is a second explanatory diagram to explain changes in individual physical strength of a friend character FC1; and

FIG. 9 is an explanatory diagram to explain changes in expected physical strength of friend characters FC1 to FC5.

### DESCRIPTION

Description follows regarding a game device 10 according to the present exemplary embodiment.

### First Exemplary Embodiment

First description follows regarding a first exemplary embodiment of the game device 10 according to the present exemplary embodiment.

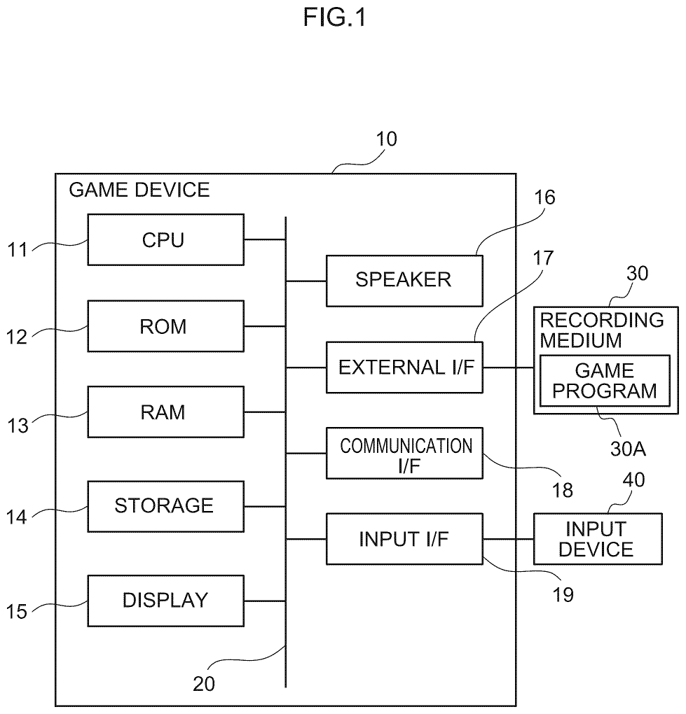

FIG. 1 is a block diagram illustrating a hardware configuration of the game device 10. The game device 10 is, for example, a home gaming console, a portable gaming console, an arcade game, a smartphone, a tablet terminal, a personal computer, or the like. The present exemplary embodiment is one in which, as an example, the game device 10 is a “home gaming console”. The game device 10 is an example of a “computer”.

As illustrated in FIG. 1, the game device 10 includes a central processing unit (CPU) 11, read only memory (ROM) 12, random access memory (RAM) 13, storage 14, a display 15, a speaker 16, an external interface (I/F) 17, and a communication I/F 18, and an input I/F 19. Each configuration is connected together through a bus 20 so as to be capable of communicating with each other.

The CPU 11 is an example of a hardware processor, and is a central processing unit that executes various programs and controls each section.

The ROM 12 stores various programs and various data. The RAM 13 serves as a work area to temporarily store programs and data.

The storage 14 is configured by a storage device such as a hard disk drive (HDD), solid state drive (SSD), flash memory, or the like, and stores various programs and various data. The ROM 12, the RAM 13, and the storage 14 correspond to memory.

The display 15 is, as an example, a liquid crystal display, and displays various information. In the present exemplary embodiment, the display 15 is a single body integrated together with the game device 10. However, there is no limitation thereto, and the display 15 may be a separate body to the game device 10. Moreover, in the present exemplary embodiment, the display 15 does not include a touch panel. However, there is no limitation thereto, and the display 15 may include an integrated touch panel.

The speaker 16 output various audio.

The external I/F 17 is an interface for connecting external devices to the game device 10. Such external devices include, as an example, a recording medium 30.

The recording medium 30 may be a non-transitory recording medium such as a compact disk read only memory (CD-ROM), digital versatile disk read only memory (DVD-ROM), universal serial bus (USB) memory, SD memory card, or the like. A game program 30A for executing a specific computer game (also called a video game, an electronic game, and the like, hereinafter simply referred to as a game) with the game device 10 is stored on the recording medium 30. The CPU 11 reads the game program 30A from the recording medium 30 through the external I/F 17, and executes the game program 30A using the RAM 13 as a work area. Note that the game program 30A is not limited to being stored on the recording medium 30, and may be prestored in the storage 14 of the game device 10, or may be downloadable to the game device 10 over a network. The game program 30A is an example of a “game program”. Note that the present disclosure is applicable to a game program and a program product including a game program, and to non-transitory computer readable recording medium recorded with a game program.

The communication I/F 18 is an interface for connecting the game device 10 to a network. A wired communication standard such as, for example, Ethernet (registered trademark), fiber distributed data interface (FDDI), or the like, or a wireless communication standard such as 4G, 5G, Wi-Fi (registered trademark), or the like, is employed in the communication I/F 18.

The input I/F 19 is an interface for connecting to an input device 40. The input device 40 is a controller, a mouse, a keyboard, or the like including operation buttons, direction keys, and the like employed perform various inputs. A user performs operation of the game using the input device 40. Operation information indicating content of input operations performed by a user using the input device 40 is stored on the RAM 13. In the present exemplary embodiment, the input device 40 is a separate body to the game device 10. However, there is no limitation thereto, and the input device 40 may be a single body integrated together with the game device 10. The input device 40 may also be detachably attached to the game device 10. There may be one or plural of the input devices 40.

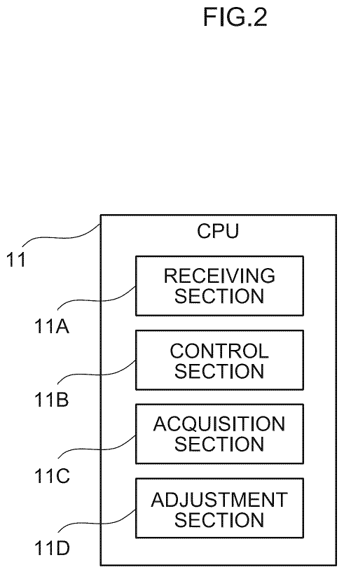

Next, description follows regarding a functional configuration of the game device 10. FIG. 2 is a first block diagram illustrating an example of a functional configuration of the game device 10.

As illustrated in FIG. 2, the CPU 11 of the game device 10 includes, as functional configuration, a receiving section 11A, a control section 11B, an acquisition section 11C, and an adjustment section 11D. Each of the functional configuration is implemented by the CPU 11 reading the game program 30A stored on the recording medium 30 and executing the game program 30A.

The receiving section 11A receives input operations from the user using the input device 40.

The control section 11B controls progression of a game based on input operations of the user received by the receiving section 11A and on information and the like defined in the game program 30A.

The game referred to above has characteristics of a game in which a multiplayer-multiplayer battle is performed with game objects of a player side and game objects of an enemy side. The game objects are objects that appear in the game, such as characters, weapons, gimmicks, and the like. Characters are people, animals, robots, machines, imaginary creatures, and the like that appear in the game, and there is no particular limitation to types thereof. The following describes game objects that perform a battle in this game as people characters. Characters on the player side are sometimes referred to as friend characters, and the characters on the enemy side are sometimes referred to as enemy characters. As an example, friend characters and enemy characters are characters other than a player character that the user is able to operate, so-called non-player characters (NPCs). Reference above to “battle” is merely an example of a “fight”. A “fight”, in addition to a “fight as a battle” in which life or death is risked in the game as described above, also includes a “fight as a competition” as performed in various sports such as baseball, soccer, and the like.

Moreover, in the game described above, based on information displayed on the display 15, a user can ascertain a result of a fight battle between a friend character and an enemy character, specifically the respective life or death of the friend characters or the enemy characters. In the game described above, a character who has died as a result of a battle disappears from game space. This means that the user is able to ascertain that a character has died by this character who was being displayed on the display 15 disappearing from the display 15.

The control section 11B performs a battle in a first manner in cases in which a user is unable to ascertain the course of a battle. The first manner is a manner in which evidence of damage occurring in a battle is not associated with motion of characters. Damage occurs periodically when a battle is performed in the first manner, specifically every time a specific period of time elapses. Note that damage is a parameter of a character arising from an attack or the like, and specifically is a unit representing an amount of a reduction in physical strength.

The motion referred to above means a movement of a character, and specifically a movement executable during a battle, such as an attack motion, a defense motion, an avoidance motion, and the like. In the game described above, cases in which a battle is performed without the motion of characters being displayed on the display 15 are cases in which a user is unable to ascertain a course of the battle.

The first manner is a manner that reduces a group physical strength set for a specific group that is a group of plural characters each time a specific period of time elapses. The specific group may be a friend group that is a group of friend characters, and may be an enemy group that is a group of enemy characters. The group physical strength is set to a freely selected value such as 2000, 2500, 3000, or the like as an initial value for each specific group. For example, when performing a battle in the first manner, a group physical strength is reduced by a specific amount each time a specific period of time elapses. The group physical strength is an example of a “first parameter”.

Next, in cases in which a user is able to ascertain the course of a battle, the control section 11B performs a battle in a second manner and with all or part of the first manner. Namely, for cases in which the user is able to ascertain the course of a battle, the control section 11B performs the battle by combining the first manner and the second manner. The second manner is a manner in which evidence of damage occurring in a battle is associated with motions of characters. Damage is generated irregularly in cases in which a battle is performed in the second manner, an is specifically generated based on a known collision determination. Moreover, in the game described above, cases in which a battle is performed with the motion of characters displayed on the display 15 are cases in which a user can ascertain the course of a battle.

Moreover, the second manner is a manner that reduces an individual physical strength set for an individual character contained in plural characters configuring a specific group based on a known collision determination. The individual physical strength is set with a freely selected value such as 150, 200, or 250, or motion of a character the like as an initial value for each individual character. For example, in cases in which a battle is performed in the second manner, the individual physical strength is reduced by a damage amount of an individual character generated by receiving an attack from an enemy character. The individual character is an example of a “specific object”, the individual physical strength is an example of a “second parameter”.

Moreover, the control section 11B performs the following control in cases in which the group physical strength has become a lowest value, namely “0”. As an example, the control section 11B performs control different in cases in which a user is unable to ascertain the course of a battle to cases in which a user is able to ascertain the course of a battle. Specifically, in cases in which a user is able to ascertain the course of a battle, the control section 11B causes plural characters configuring a specific group whose group physical strength has become “0” to disappear from game space. On the other hand, in cases in which a user is able to ascertain the course of a battle, the control section 11B maintains the plural characters in game space and then afterwards, based on having received an attack from an enemy character, causes an individual character who has received an attack to disappear from game space.

Moreover, in cases in which an individual physical strength has become a lowest value, namely “0”, the control section 11B causes an individual character whose individual physical strength has become “0” to disappear from game space.

The acquisition section 11C acquires various information related to the game. For example, the acquisition section 11C periodically acquires position information, time information, and physical strength information as various information.

The position information is information indicating positions of game objects in game space. A world coordinate system, which is a coordinate system for defining positions in game space, is set in game space. The positions of game objects can be defined in the world coordinate system.

For example, the acquisition section 11C acquires character position information, friend group position information, and enemy group position information. The character position information includes position information of a player character, friend characters, and enemy characters. The character position information indicates, in the world coordinate system described above, three-dimensional coordinate values of intersection points between a body axis of a character and a ground surface defined in game space. Moreover, the acquisition section 11C acquires, as friend group position information, position information of freely selected friend character(s) from out of plural friend characters when there is position information of plural friend characters present within a specific range. Furthermore, the acquisition section 11C acquires, as enemy group position information, position information of freely selected enemy character(s) from out of plural enemy characters when there is position information of plural enemy characters present within a specific range.

The time information is information indicating elapse of time during a battle between a friend group and an enemy group. The acquisition section 11C starts to measure time information when friend group position information and enemy group position information are within a specific distance, and acquires periodically measured time information.

The physical strength information is information indicating respective group physical strengths of friend groups and enemy groups, respective individual physical strengths of friend characters and enemy characters, and information indicating respective expected physical strengths of friend characters and enemy characters. The expected physical strength is a parameter of respective physical strength simulated for friend characters and enemy characters, and is computed by dividing the group physical strength by the plural number of characters configuring a specific group. Note that the control section 11B maintains an individual character whose expected physical strength has become “0” in game space, even though the expected physical strength has become the lowest value, namely “0”. The expected physical strength is an example of a “third parameter”.

The adjustment section 11D adjusts a reduction amount of individual physical strength for cases in which a user is able to ascertain the course of a battle. For example, in cases in which an individual character has received an attack by a battle in the second manner and the individual physical strength of this individual character is to be reduced, the adjustment section 11D decides whether or not to increase a reduction amount of this individual physical strength based on group physical strength of a specific group that this individual character belongs to and on this individual physical strength as indicated in the physical strength information acquired by the acquisition section 11C. Specifically, in cases in which this individual physical strength is greater than an expected physical strength found by dividing this group physical strength by the plural number of characters configuring this specific group, the adjustment section 11D adds a difference (delta) between this individual physical strength and the expected physical strength to a reduction amount of this individual physical strength to be reduced in the second manner.

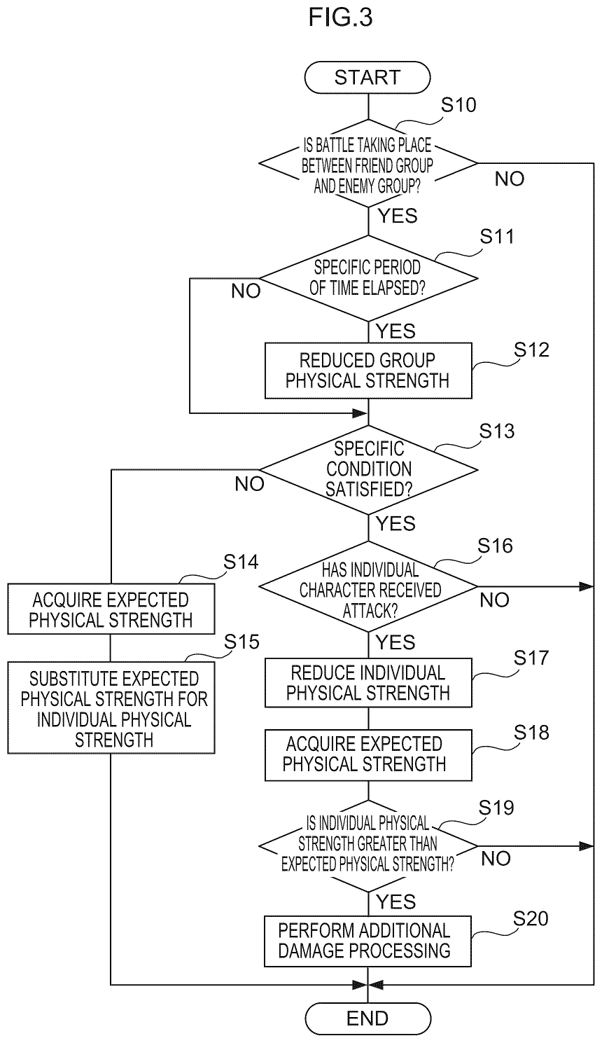

FIG. 3 is a flowchart illustrating a flow of particular processing that the game device 10 executes. The CPU 11 reads the game program 30A from the recording medium 30, and performs the particular processing by expanding and executing the game program 30A in the RAM 13. The particular processing illustrated in FIG. 3 is, for example, repeatedly executed automatically by being executed each time a given period of time elapses.

At step S10 of FIG. 3, the CPU 11 determines whether or not a battle between a friend group and an enemy group is taking place. The CPU 11 proceeds to step S11 in cases in which determination is that a battle is taking place (step S10: YES). On the other hand, the CPU 11 ends the particular processing in cases in which determination is that a battle is not taking place (step S10: NO). As an example, the CPU 11 determines that a battle between a friend group and an enemy group is taking place when friend group position information and enemy group position information are within a specific distance.

At step S11, the CPU 11 determines whether or not a specific period of time has elapsed. The CPU 11 proceeds to step S12 when determined that the specific period of time has elapsed (step S11: YES). On the other hand, the CPU 11 proceeds to step S13 when determined that the specific period of time has not elapsed (step S11: NO).

At step S12, the CPU 11 makes a subtraction to the respective group physical strength of the friend group and the enemy group. As an example, the CPU 11 subtracts, from the group physical strength, a value resulting from multiplying a fixed value (for example: 10) by the number of characters configuring a specific group. For example, in cases in which the number of friend characters configuring the friend group is eight, the CPU 11 subtracts 80 from the group physical strength of the enemy group. Moreover, in cases in which the number of enemy characters configuring the enemy group is ten, the CPU 11 subtracts 100 from the group physical strength of the friend group. The CPU 11 then proceeds to step S13.

At step S13, the CPU 11 determines whether or not a specific condition has been satisfied. The CPU 11 proceeds to step S16 in cases in which determination is that the specific condition has been satisfied (step S13: YES). On the other hand, the CPU 11 proceeds to step S14 in cases in which determination is that the specific condition has not been satisfied (step S13: NO). As an example, the CPU 11 determines that the specific condition has been satisfied in cases in which the position information of the player character and the position information of the friend group and the enemy group are within a specific distance and the user is also able to ascertain the course of a battle.

At step S14 the CPU 11 acquires the expected physical strength. Specifically, the CPU 11 acquires an expected physical strength of friend characters computed by dividing the group physical strength of the friend group by the number of friend characters configuring this friend group. Moreover, the CPU 11 acquires an expected physical strength of enemy characters computed by dividing the group physical strength of the enemy group by the number of enemy characters configuring this enemy group. The CPU 11 then proceeds to step S15.

At step S15, the CPU 11 substitutes the expected physical strength for the individual physical strength. Specifically, the CPU 11 substitutes the expected physical strength of the friend characters acquired at step S14 for the individual physical strength of the friend characters. Moreover, the CPU 11 substitutes the expected physical strength of the enemy characters acquired at step S14 for the individual physical strength of the enemy characters. The CPU 11 then ends the particular processing.

At step S16, the CPU 11 determines whether or not an individual character has received an attack. The CPU 11 proceeds to step S17 in cases in which determination is that the individual character has received an attack (step S16: YES). On the other hand, the CPU 11 ends the particular processing in cases in which determination is that the individual character has not received an attack (step S16: NO). As described above, the CPU 11 determines whether or not the individual character has received an attack based on a known collision determination.

At step S17, the CPU 11 makes a subtraction from an individual physical strength of the individual character determined to have received an attack at step S16. When doing so, the CPU 11 subtracts a damage amount occurring due to the individual character receiving an attack, for example 50, from the individual physical strength. The CPU 11 then proceeds to step S18.

At step S18, the CPU 11 acquires an expected physical strength of the individual character resulting from the subtraction made from the individual physical strength at step S17. Specifically, the CPU 11 acquires an expected physical strength computed by dividing the group physical strength of the specific group that this individual character belongs to by the number of characters configuring this specific group. The CPU 11 then proceeds to step S19.

At step S19, the CPU 11 determines whether or not the individual physical strength after making the subtraction at step S17 is greater than the expected physical strength acquired at step S18. The CPU 11 proceeds to step S20 when determination is that the individual physical strength is greater than the expected physical strength (step S19: YES). On the other hand, the CPU 11 ends the particular processing when determination is that the individual physical strength is less than the expected physical strength (step S19: NO).

At step S20, the CPU 11 performs additional damage processing. Specifically, the CPU 11 makes an additional subtraction from the individual physical strength of a difference between the individual physical strength after the subtraction made at step S17 and the expected physical strength acquired at step S18. The CPU 11 then ends the particular processing.

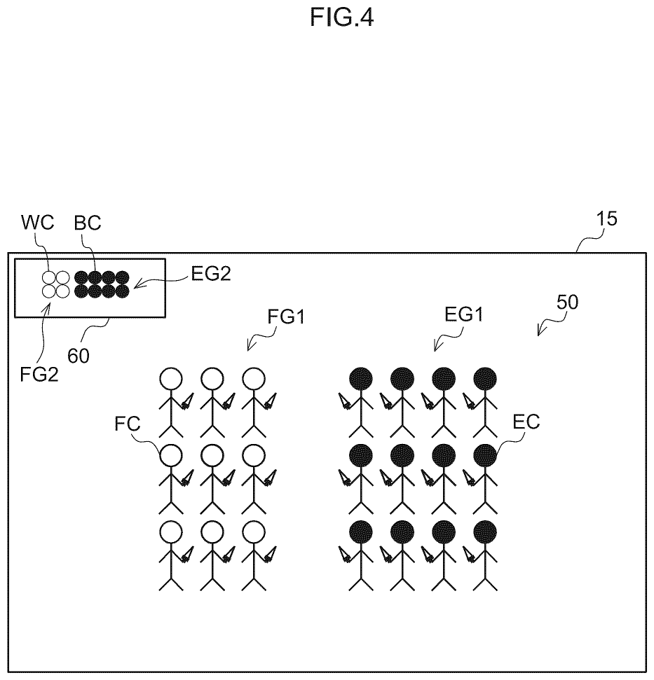

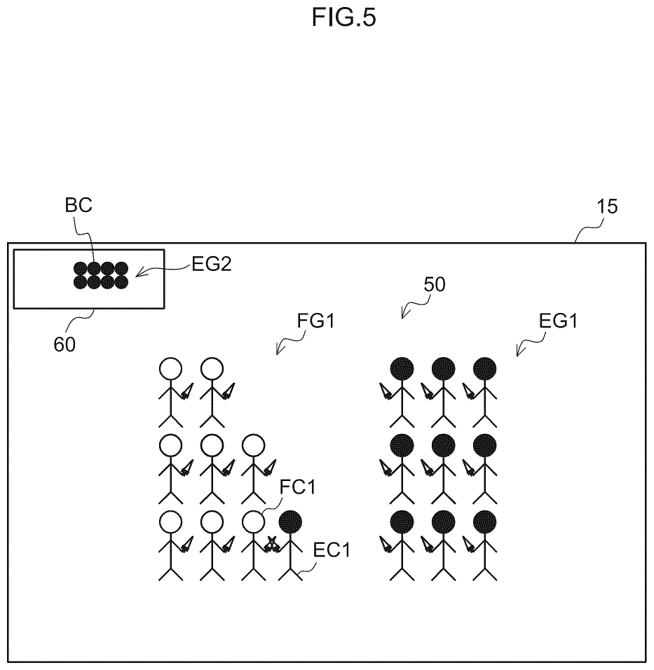

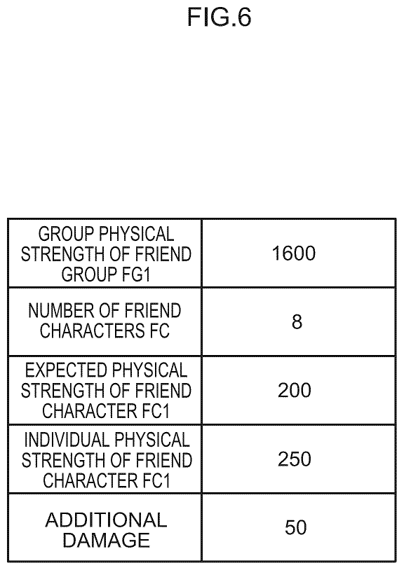

Next, description follows regarding a specific example of the particular processing illustrated in FIG. 3, with reference to FIG. 4, FIG. 5, and FIG. 6. FIG. 4 is an example of a first display displayed on the display 15 of the game device 10.

The display 15 illustrated in FIG. 4 includes two display areas, a main display area 50 and a sub display area 60. The main display area 50 and the sub display area 60 have a common point in that they display a battle between a friend group and an enemy group, but differ in whether or not a user is able to ascertain the course of a battle. Specifically, a user is able to ascertain the course of a battle for a battle performed in the main display area 50, and a user is unable to ascertain the course of a battle for a battle performed in the sub display area 60. This means that the CPU 11 performs a battle combining the first manner and the second manner for a battle performed in the main display area 50. In other words, the CPU 11 employs the group physical strength and the individual physical strength to decide the result of a battle between the friend group and the enemy group for a battle in the main display area 50. On the other hand, the CPU 11 performs the battle in the first manner for a battle performed in the sub display area 60. In other words, the CPU 11 employs only the group physical strength to decide the result of a battle between a friend group and an enemy group for a battle performed in the sub display area 60.

Nine friend characters FC and twelve enemy characters EC are displayed on the main display area 50 illustrated in FIG. 4. As an example, people shaped characters with white heads indicate friend characters FC in the main display area 50, and people shaped characters with black heads indicate enemy characters EC therein. In the main display area 50, a friend group FG1 is formed from the nine friend characters FC, and an enemy group EG1 is formed from the twelve enemy characters EC. The friend characters FC and the enemy characters EC displayed on the main display area 50 adopt respective motions, such as an attack motion, a defense motion, and an avoidance motion, and perform a battle. In a battle performed in the main display area 50, a character whose individual physical strength has become “0” dies as a battle result, and disappears from the main display area 50. When this occurs, the user is able to ascertain the course of a battle between the friend group FG1 and the enemy group EG1 by looking at the motions of each of the characters displayed on the main display area 50. Moreover, the user is able to ascertain the result of the battle between the friend group FG1 and the enemy group EG1 from a character that was being displayed on the main display area 50 disappearing from the main display area 50.

Four white circles WC and eight black circles BC are displayed in the sub display area 60 illustrated in FIG. 4. In the sub display area 60, the characters are not represented by people shapes as in the main display area 50, and are represented by a graphic of a character. As an example, in the sub display area 60 a single white circle WC indicates a single friend character FC, and a single black circle BC indicates a single enemy character EC. A friend group FG2 is formed from four white circles WC in the sub display area 60, and an enemy group EG2 is formed from eight black circles BC therein. A battle performed in the sub display area 60 differs from a battle performed in the main display area 50 in progressing without being accompanied by the motions of characters. In a battle performed in the sub display area 60, a character configuring a specific group whose group physical strength has become “0” dies as a battle result, and the graphic indicating the character of either a white circle WC or a black circle BC disappears from the sub display area 60. This means that a user is unable to ascertain the course of a battle performed between the friend group FG2 and the enemy group EG2 even when looking at the sub display area 60. On the other hand, a user is able to ascertain the result of the battle between the friend group FG2 and the enemy group EG2 from a graphic that was being displayed on the sub display area 60 disappearing from the sub display area 60.

FIG. 5 is an example of a second display displayed on the display 15 of the game device 10. FIG. 5 indicates a state after elapse of a specific period of time from the display example illustrated in FIG. 4 being displayed on the display 15.

Eight friend characters FC and ten enemy characters EC are displayed on the main display area 50 illustrated in FIG. 5. Thus in the main display area 50 illustrated in FIG. 5, one friend character FC and two enemy characters EC have died and disappeared as a battle result. Moreover, in the sub display area 60 illustrated in FIG. 5, the friend characters FC configuring the friend group FG2 whose group physical strength has become “0” die as a battle result, and the four white circles WC representing these friend characters FC have disappeared.

Moreover, in the main display area 50 illustrated in FIG. 5, an enemy character EC1 has approached the friend character FC1, and these two characters adopt motions and perform a battle. The display example illustrated in FIG. 5 is one in which the friend character FC1 has received an attack from the enemy character EC1, and changes to the individual physical strength of the friend character FC1 will now be described with reference to FIG. 6.

FIG. 6 is a first explanatory diagram to explain changes in individual physical strength of the friend character FC1.

As illustrated in FIG. 6, the group physical strength of the friend group FG1 when the friend character FC1 has received an attack is, for example, reduced from an initial value of 2000 to 1600, based on the specific period of time elapsed during the battle. Moreover, the number of friend characters FC configuring the friend group FG1 when the friend character FC1 has received an attack is eight, and so the expected physical strength of the friend character FC1 is 200. The individual physical strength of the friend character FC1 after the attack has been received is 250. This means that a difference of 50 between the individual physical strength “250” and the expected physical strength “200” is additional damage to be additionally subtracted from the individual physical strength. The individual physical strength of the friend character FC1 after additional damage processing has been performed is accordingly 200. The additional damage is an example of an “an increase amount to increase a reduction amount of the second parameter”.

In games in which the user is able to ascertain battle results, hitherto battles have sometimes been performed using a different method depending on whether or not the user has been able to ascertain the course of a battle, for example using one manner out of a first manner or a second manner. When doing so, due to the method employed in the battle depending on whether or not the user is able to ascertain the course of a battle, a difference has appeared in battle result according to the method employed. This means that a user has sometimes experienced the feeling of a gap between a battle result they themselves expect and actual battle results.

In contrast thereto, for games in which the user is able to ascertain battle results, the CPU 11 performs a battle in the first manner when the user is unable to ascertain the course of a battle, and performs a battle in the second manner and with all or part of the first manner when the user is able to ascertain the course of a battle. For example, there are cases in which, based on a result of a battle performed in the sub display area 60 using the first manner, a user expects a result of a battle being performed in the main display area 50 for which the user is able to ascertain the course of the battle. In such cases, in the game device 10 according to the first exemplary embodiment, by combining the first manner in the second manner to generate a result of a battle performed in the sub display area 60 with the result of a battle being performed in the main display area 50 as a basis for expectation, a difference between results of the two battles can be reduced. This means that the game device 10 is able to reduce a gap between a battle result expected by a user and the actual battle result, compared to a configuration in which a battle is not performed with a combination of plural methods.

Moreover, the first manner does not associate evidence of damage generated in a battle with motions of characters, and the second manner does associate evidence of damage generated in a battle with motions of characters. Specifically, damage when a battle is performed in the first manner is generated each time a specific period of time elapses, and damage when a battle is performed in the second manner is generated based on a known collision determination. For a battle in which motions of characters are not displayed on the display 15 in which it is difficult for a user to ascertain the course of a battle, in the game device 10 according to the first exemplary embodiment a user is able to ascertain the course of a battle for a battle in which the motions of characters are displayed on the display 15.

Reference in the above description to “when a user is unable to ascertain a course of the battle” may, for example, be stated in other words as “when evidence of damage generated in a battle is not associated with motions of characters”. Similarly, reference in the above description to “when a user is able to ascertain a course of the battle” may, for example, be stated in other words as “when evidence of damage generated in a battle is associated with motions of characters”.

Moreover, the first manner is a manner to periodically reduce a group physical strength set for a specific group that is a group of plural characters, and the second manner is a manner to irregularly reduce an individual physical strength set for an individual character contained in plural characters. The CPU 11 then, when reducing the individual physical strength of an individual character who is an individual character who has received an attack in a battle in the second manner, decides whether or not to increase a reduction amount of this individual physical strength based on group physical strength of the specific group that this individual character belongs to and on this individual physical strength. Specifically, when reducing the individual physical strength of this individual character, if the individual physical strength is greater than the expected physical strength resulting from dividing this group physical strength by the plural number of characters configuring this specific group, the CPU 11 adds a difference between this individual physical strength and expected physical strength to the reduction amount of this individual physical strength to be reduced by the second manner. The game device 10 according to the first exemplary embodiment is accordingly able to decide the reduction amount of individual physical strength by a method that combines plural methods. Moreover, the game device 10 enables the reduction amount of individual physical strength for irregular reduction in the second manner to be increased based on the group physical strength that is reduced periodically by the first manner, and thereby enables a randomness related to the reduction in individual physical strength to be reduced compared to a configuration in which the individual physical strength is reduced using only the second manner.

### Second Exemplary Embodiment

Next, description follows regarding a second exemplary embodiment of the game device 10 according to the present exemplary embodiment, while omitting or simplifying description of duplicate portions to those of the above exemplary embodiment.

The second exemplary embodiment differs from the first exemplary embodiment in the point that a normal character, and a special character having an individual physical strength greater than a normal character, are provided as individual characters. The normal character is an example of a “normal object”, and the special character is an example of a “special object”. Note that the individual character described in the first exemplary embodiment corresponds to a normal character, and the second exemplary embodiment will be described centering on a case in which the individual character is a special character.

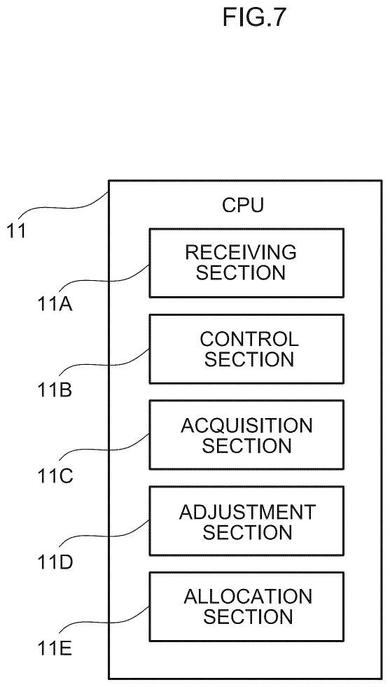

FIG. 7 is a second block diagram illustrating an example of a functional configuration of the game device 10.

As illustrated in FIG. 7, the CPU 11 of the game device 10 includes, as functional configuration, a receiving section 11A, a control section 11B, an acquisition section 11C, an adjustment section 11D, and an allocation section 11E. Each of the functional configuration is implemented by the CPU 11 reading a game program 30A stored on the recording medium 30 and executing the game program 30A.

In the second exemplary embodiment, when a battle is performed in the first manner, the acquisition section 11C acquires a group physical strength and a special physical strength, different to the individual physical strength of a special character. The special physical strength is, similarly to the expected physical strength, a parameter such that the special character is maintained in game space without disappearing even when at the lowest value, namely when it has become “0”. The special physical strength is set with a freely selected value such as 350, 400, 450, or the like as an initial value. The acquisition section 11C acquires the individual physical strength and the special physical strength of the special character when reducing the individual physical strength of the special character who is a special character who has received an attack in a battle of the second manner. The special physical strength is an example of a “special parameter”.

The allocation section 11E allocates a reduction amount of parameter by the first manner across a deduction from group physical strength and a deduction from special physical strength. As an example, when the reduction amount of this parameter by the first manner is 100, the allocation section 11E allocates 50 as a deduction from the group physical strength and allocates 50 as a deduction from the special physical strength.

In the second exemplary embodiment, when reducing the individual physical strength of the special character, who is a special character who has received an attack in a battle in the second manner, if the individual physical strength of the special character is greater than the special physical strength, the adjustment section 11D adds a difference between the individual physical strength of the special character and special physical strength to the reduction amount of individual physical strength of the special character for reducing in the second manner.

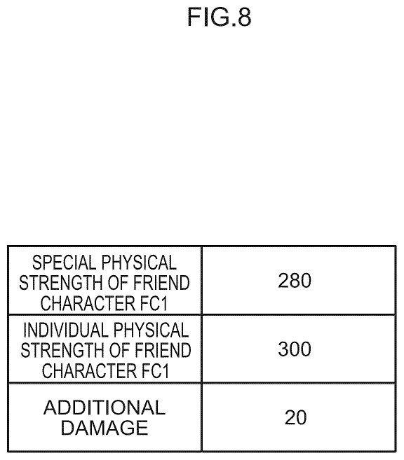

Next, description follows regarding a case in which, in the example display illustrated in FIG. 5, a friend character FC1 serving as a special character who has received an attack from an enemy character EC1, regarding changes in individual physical strength of the friend character FC1 with reference to FIG. 8.

FIG. 8 is a second explanatory diagram to explain changes in individual physical strength of the friend character FC1.

As illustrated in FIG. 8, the special physical strength of the friend character FC1 after an attack has been received is 280, and the individual physical strength is 300. This means that a difference of 20 between the individual physical strength “300” and the special physical strength “280” is used as additional damage to be additionally subtracted from the individual physical strength. This means that the individual physical strength of the friend character FC1 is 280 after performing the additional damage processing.

As described above, the CPU 11 acquires a group physical strength and a special physical strength when a battle is performed in the first manner, and allocates the reduction amount of the parameter from the first manner across a deduction from the group physical strength and a deduction from the special physical strength. The CPU 11 then, when reducing the individual physical strength of a normal character who is a normal character who has received an attack in a battle in the second manner, similarly to in the first exemplary embodiment, acquires the individual physical strength and the group physical strength of the normal character, and also, if the individual physical strength of the normal character is greater than the expected physical strength of the normal character, adds a difference between the individual physical strength of the normal character and the expected physical strength of the normal character to the reduction amount of the individual physical strength of the normal character to be reduced by the second manner. On the other hand, when reducing the individual physical strength of a special character who is a special character that has received an attack in a battle in the second manner, the CPU 11 acquires the individual physical strength and the special physical strength of the special character, and also, if the individual physical strength of the special character is greater than the special physical strength, adds a difference between the individual physical strength and the special physical strength of the special character to the reduction amount of the individual physical strength of the special character to be reduced by the second manner.

Due to the above configuration, the game device 10 according to the second exemplary embodiment is able to use different parameters for the normal character and for the special character to decide an additional damage to the individual physical strength. The game device 10 is accordingly able to provide a game characteristic such as a special character being more liable to die before a normal character, or a normal character being more liable to die before a special character.

### Third Exemplary Embodiment

Next, description follows regarding a third exemplary embodiment of a game device 10 according to the present exemplary embodiment, while omitting or simplifying description of duplicate portions to those of the above exemplary embodiments.

Functional configuration of the game device 10 according to the third exemplary embodiment is, as an example, similar to in the second exemplary embodiment, and is the functional configuration illustrated in FIG. 7.

In the third exemplary embodiment, the adjustment section 11D sets a specific upper limit for the additional damage when the additional damage exceeds a reference value, or when an individual character whose individual physical strength is to be reduced is in a specific state. This additional damage is a difference between the individual physical strength of a normal character and the expected physical strength of a normal character, or is a difference between the individual physical strength and the special physical strength of a special character. The reference value is a freely selected value such as 50, 70, or 100. The reference value is 50 in the following description. Cases in which the individual character is in a specific state include, for example, cases in which an effect raising a defense parameter is given to the individual character, and cases in which a type of attack received by the individual character is a particular type (a so-called weak attack). Explanation follows regarding a case in which the individual character is in a specific state for when the type of attack received by the individual character is a weak attack. This specific upper limit is a freely selected value not more than the reference value, such as 20, 30, or 40. The specific upper limit is 30 in the following description.

For example, when the additional damage exceeds 50, which is the reference value, the adjustment section 11D sets the additional damage of reduction from the individual physical strength to 30, which is the specific upper limit. When the type of attack received by the individual character whose individual physical strength is to be reduced is a weak attack, the adjustment section 11D sets the upper limit of the additional damage to 30, which is the specific upper limit.

Adopting the configuration described above means that, in the game device 10 according to the third exemplary embodiment, an unsettling feeling imparted to a user can be reduced compared to a configuration in which an specific upper limit is not set for the additional damage. For example, the game device 10 enables a reduction to be achieved in events in which the individual character dies due to the additional damage when a weak attack has been received.

### Fourth Exemplary Embodiment

Next, description follows regarding a fourth exemplary embodiment of a game device 10 according to the present exemplary embodiment, while omitting or simplifying description of duplicate portions to those of the above exemplary embodiments.

The functional configuration of the game device 10 according to the fourth exemplary embodiment is, as an example, similar to in the second exemplary embodiment, and is the functional configuration illustrated in FIG. 7.

In the fourth exemplary embodiment, the control section 11B performs control to raise the possibility that the individual physical strength of a normal character is reduced as an individual character when the individual physical strength is greater than the expected physical strength. For example, as this control, the control section 11B controls this normal character so as to approach an enemy character, controls this normal character so as to lower a defense success rate or an avoidance success rate, controls an enemy character so as to approach this normal character, or controls so as to raise an attack success rate of an enemy character. Note that the control section 11B may perform one out of the above controls, or may perform a combination of plural controls therefrom.

Due to adopting the configuration described above, the game device 10 according to the fourth exemplary embodiment enables a difference between the individual physical strength and the expected physical strength of a normal character to be made smaller than in a configuration in which control is not performed to raise the possibility that the individual physical strength of a normal character is reduced.

Note that the control section 11B may perform the control described above not only on a normal character, and may also perform the control described above on a special character. Namely, the control section 11B may perform control to raise the possibility that the individual physical strength of a special character is reduced when the individual physical strength is greater than the special physical strength.

### Fifth Exemplary Embodiment

Next, description follows regarding a fifth exemplary embodiment of a game device 10 according to the present exemplary embodiment, while omitting or simplifying description of duplicate portions to those of the above exemplary embodiments.

The functional configuration of the game device 10 according to the fifth exemplary embodiment is, as an example, similar to in the second exemplary embodiment, and is the functional configuration illustrated in FIG. 7.

In the fifth exemplary embodiment, in cases in which the expected physical strength has become a specific threshold or lower, such that the expected physical strength exceeds the specific threshold, the adjustment section 11D reduces a plural number of characters serving as the divisor in a computation equation of the expected physical strength computed by dividing the group physical strength of a specific group by the plural number of characters configuring the specific group. The adjustment section 11D then sets a new expected physical strength computed based on this computation equation for some individual characters corresponding to the new divisor from out of all the individual characters corresponding this specific group, and sets “0” as the expected physical strength for the remaining individual characters. The specific threshold is a freely selected value such as 45, 75, or 95. The specific threshold is 45 in the following description.

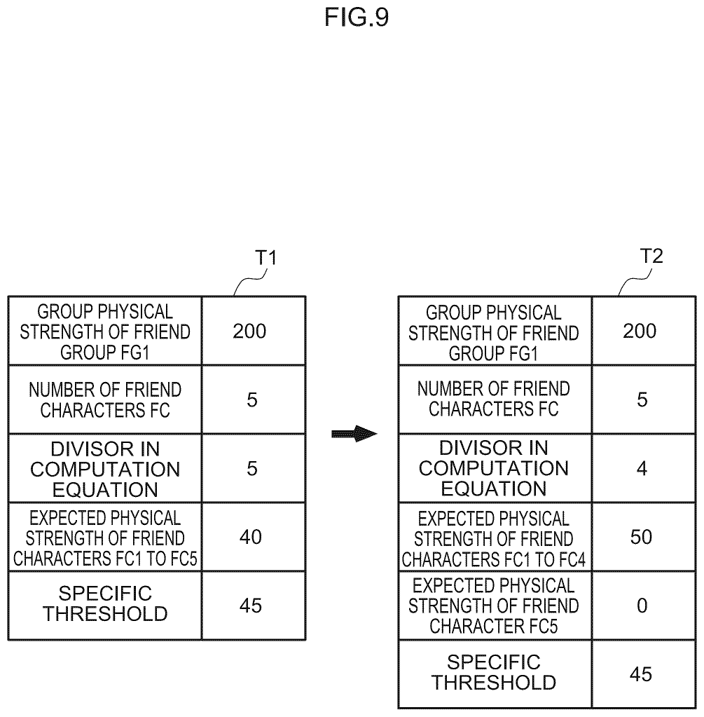

Next, description follows regarding changes to the expected physical strength of five friend character FC1 to FC5 configuring a friend group FG1, with reference to FIG. 9.

FIG. 9 is an explanatory diagram to explain changes to the expected physical strength of the friend character FC1 to FC5. In FIG. 9, a state prior to the expected physical strength being adjusted by the CPU 11 is indicated in Table T1, and a state after the expected physical strength has been adjusted by the CPU 11 is indicated in Table T2.

In Table T1, the group physical strength of a friend group FG1 is 200, the number of friend characters FC configuring the friend group FG1 is five. Moreover, in Table T1, the divisor in the computation equation of the expected physical strength is similarly 5, the number of friend characters FC. This means that in the Table T1, the expected physical strength of the friend character FC1 to FC5 is 40. In such cases, the expected physical strength indicted in Table T1 is not less than the specific threshold 45, and so adjustment of expected physical strength is performed by the CPU 11.

As illustrated in Table T2, the CPU 11 accordingly reduces the divisor in the computation equation of the expected physical strength from 5 to 4 such that the expected physical strength exceeds the specific threshold. The CPU 11 sets 50, which is the new expected physical strength computed based on this computation equation, for the four friend characters FC1 to FC4 corresponding to the new divisor of four from out of the friend characters FC1 to FC5. Moreover, the CPU 11 sets “0” for the expected physical strength in the remaining friend character FC5.

When doing so, the CPU 11 maintains the friend character FC5 whose expected physical strength has become “0” in game space, and specifically continues to display the friend character FC5 on the main display area 50. The CPU 11 then performs additional damage processing in cases in which the friend character FC5 has received an attack in a battle in the second manner and the individual physical strength of the friend character FC5 is to be reduced, makes the individual physical strength “0” and causes the friend character FC5 to disappear from game space.

Due to the above configuration, the game device 10 according to the fifth exemplary embodiment is able to individually adjust the expected physical strength of plural characters configuring a specific group. This means that the game device 10 is able to provide a game characteristic in which a freely selected individual character is more liable to die than another individual character.

### Sixth Exemplary Embodiment

Next description follows regarding a sixth exemplary embodiment of a game device 10 according to the present exemplary embodiment, while omitting or simplifying description of duplicate portions to those of the above exemplary embodiments.

The functional configuration of the game device 10 according to the sixth exemplary embodiment is, as an example, similar to in the second exemplary embodiment, and is the functional configuration illustrated in FIG. 7.

In the sixth exemplary embodiment, in cases in which the user is able to ascertain the course of a battle, in contrast to in the above exemplary embodiments, the adjustment section 11D decides additional damage without using group physical strength. As an example, when the user is able to ascertain the course of a battle, the adjustment section 11D adds a weighted value to the damage generated in the first manner to the damage generated in the second manner. The weighting may be to increase or may be to decrease the damage generated in the first manner. Here 0.5 times is taken as the weighting for the damage generated in the first manner. For example, when damage has been generated in the second manner, namely, when an individual character has received an attack by a battle in the second manner, a damage of 50 is, say, generated in a battle in the first manner. In such cases, the adjustment section 11D adds 0.5 times 50, i.e. 25, to the damage generated in the second manner.

By adopting the configuration described above, the game device 10 according to the sixth exemplary embodiment is able to decide the additional damage to the individual physical strength while using the damage generated in the first manner directly.

### OTHER EMBODIMENTS

In the above exemplary embodiments, the group physical strength may be reduced by a predetermined given amount each time a specific period of time elapses, and may be reduced with an amount decided each time a specific period of time elapses. Moreover, the reduction amount of the group physical strength may be decided based on a state of a specific group, on an imbalance in the number of people between specific groups during battle, or the like. Furthermore, this specific period of time may be fixed, or may change at each timing.

In the above exemplary embodiments, the group physical strength may be different, or may be the same, for each friend group or for each enemy group. Moreover, the individual physical strength may be different, or may be the same, for each normal character or for each special character.

In the above exemplary embodiments, in cases in which the group physical strength has become “0”, the CPU 11 performs control different when a user is unable to ascertain the course of a battle to when able to ascertain the course of a battle, however there is no limitation thereto. In cases in which the group physical strength has become “0”, the CPU 11 may perform control that is the same both when a user is unable to ascertain the course of a battle or is able to ascertain the course of a battle. For example, when the group physical strength has become “0”, irrespective of whether or not a user is able or unable to ascertain the course of a battle, the CPU 11 may cause plural characters configuring the specific group whose group physical strength has become “0” to disappear from game space, and may maintain these plural characters in game space.

In the above exemplary embodiments, even though the expected physical strength has become “0”, the CPU 11 has maintained an individual character whose expected physical strength has become “0”, specifically a normal character, in game space, however there is no limitation thereto. In cases in which the expected physical strength has become “0”, the CPU 11 may cause the normal character whose expected physical strength has become “0” to disappear from game space.

In the above exemplary embodiments, even when the special physical strength has become “0”, the CPU 11 has maintained the special character whose special physical strength has become “0” in game space, however there is no limitation thereto. In cases in which the special physical strength has become “0”, the CPU 11 may cause the special character whose special physical strength has become “0” to disappear from game space.

Although in the above exemplary embodiments, the CPU 11 has taken a reduction amount of the parameter from the first manner and allocated it half-and-half between a deduction from the group physical strength and a deduction from the special physical strength, there is no limitation thereto. For example, The CPU 11 may allocate such that the deduction from the group physical strength is more or less than the deduction from the special physical strength, and may allocate such that the deduction from the special physical strength is more or less than the deduction from the group physical strength.

Moreover, although in the above exemplary embodiments, the CPU 11 has set a specific upper limit to the additional damage when the additional damage exceeds a reference value, or when an individual character whose individual physical strength is to be reduced is in a specific state, there is no limitation thereto. The CPU 11 may set a specific upper limit to the additional damage when at least one case occurs out of a case in which the additional damage exceeds a reference value, or a case in which an individual character whose individual physical strength is to be reduced is in a specific state.

Although in the above exemplary embodiment, a specific upper limit to set for the additional damage was a fixed value, there is no limitation thereto. For example, the specific upper limit may be a specific proportion for multiplying the damage generated when an individual character has received an attack, may be a specific proportion for multiplying the individual physical strength of the individual character, and there is no particular limitation thereto.

In the above exemplary embodiments a character to be subjected to additional damage processing was an NPC, however there is no limitation thereto. For example, characters to be subjected to additional damage processing may be only NPCs, may be only player characters, and may be both NPCs and player characters.

In the above exemplary embodiments, the battles in which additional damage processing is performed were multiplayer-multiplayer battles between a friend group and an enemy group, there is no limitation thereto. Battles in which additional damage processing is performed may be one-on-one battles between a friend character and an enemy character, and may be many-on-one battles between a friend group or an enemy group and an enemy character or a friend character.

Note that the particular processing executed in the above exemplary embodiments by the CPU 11 loading software (a program) may be executed by various processors other than a CPU. Such processors include examples such as programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Moreover, the particular processing may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Hitherto in games in which a user is able to ascertain a result of a fight, fights have sometimes been performed using different methods depending on whether or not the user is able to ascertain a course of the fight. When doing so, due to the method employed for the fight being different according to whether or not the user is able to ascertain the course of the fight, differences in the results of the fight have sometimes arisen according to the method employed. This has meant that sometimes a user has experienced the feeling of a gap between a result of a fight as expected by themselves and the actual result of the fight.

An object of the present disclosure is to reduce a gap between a fight result as expected by a user and an actual fight result, compared to a configuration in which a fight is not performed with a combination of plural methods.

A program product of a first aspect includes a game program that causes a computer to execute a process. The process includes, in a game in which it is possible that a user ascertains a result of a fight, performing the fight in a first manner in a case in which the user is unable to ascertain a course of the fight, and performing the fight in a second manner and with all or part of the first manner, in a case in which the user is able to ascertain the course of the fight.

A program product of a second aspect is the program product of the first aspect that causes a computer to execute a process, wherein the first manner is a manner that reduces a first parameter, the second manner is a manner that reduces a second parameter, and the process includes, when reducing the second parameter, increasing a reduction amount of the second parameter based on the first parameter and the second parameter.

A program product of a third aspect is the program product of the first aspect or the second aspect, wherein the first manner is a manner to periodically reduce a first parameter, and the second manner is a manner to irregularly reduce a second parameter.

A program product of a fourth aspect is the program product of the second aspect or the third aspect that causes a computer to execute a process, wherein the first parameter is a parameter that is set for a specific group that is a group of plural game objects, the second parameter is a parameter that is set for a specific object contained in the plural game objects, and the process includes, when reducing the second parameter, in a case in which the second parameter is greater than a third parameter resulting from dividing the first parameter by a number of the plural game objects, adding a difference between the second parameter and the third parameter to the reduction amount of the second parameter to be reduced in the second manner.

A program product of a fifth aspect is the program product of the fourth aspect that causes a computer to execute a process, wherein: a normal object, and a special object for which the second parameter is greater than that of the normal object, are provided as specific objects; when performing the fight in the first manner, acquiring the first parameter, and a special parameter of the special object which is different from the second parameter, and allocating a reduction amount of a parameter by the first manner across a deduction from the first parameter and a deduction from the special parameter; when reducing the second parameter of the normal object, acquiring the second parameter and the first parameter of the normal object, and, in a case in which the second parameter of the normal object is greater than the third parameter of the normal object, adding a difference between the second parameter of the normal object and the third parameter of the normal object to a reduction amount of the second parameter of the normal object to be reduced in the second manner; and when reducing the second parameter of the special object, acquiring the second parameter and the special parameter of the special object, and, in a case in which the second parameter of the special object is greater than the special parameter, adding a difference between the second parameter and the special parameter of the special object to a reduction amount of the second parameter of the special object to be reduced in the second manner.

A program product of a sixth aspect is the program product of any one of the second aspect to the fifth aspect that causes a computer to execute a process, wherein the process includes setting a specific upper limit to an increase amount in a case in which at least one of the increase amount, to increase the reduction amount of the second parameter, exceeds a reference value, or a specific object having the second parameter that is to be reduced is in a specific state.

A program product of a seventh aspect is the program product of any one of the fourth aspect to the sixth aspect that causes a computer to execute a process, wherein the process includes increasing a possibility that the second parameter of the specific object is reduced in a case in which the second parameter is greater than the third parameter.

A program product of an eighth aspect is the program product of any one of the fourth aspect to the seventh aspect that causes a computer to execute a process, wherein the process includes: in a case in which the third parameter is a specific threshold value or lower, reducing a number of the plural game objects serving as a divisor in a computation equation of the third parameter computed by dividing the first parameter by the number of the plural game objects such that the third parameter exceeds the specific threshold value; and setting the third parameter newly computed based on the computation equation for some of the specific objects corresponding to the new divisor among all of the specific objects configuring the specific group, and setting a lowest value of the third parameter for a remainder of the specific objects.

A program product of a ninth aspect is the program product of any one of the first aspect to the eighth aspect, wherein in the first manner, evidence of damage generated in the fight does not associate with motions of game objects, and in the second manner, evidence of damage generated in the fight associates with the motions of the game objects.

A program product of a tenth aspect is the program product of any one of the first aspect to the ninth aspect that causes a computer to execute a process, wherein the process includes, in a case in which the user is able to ascertain the course of the fight, adding a weighted value of damage generated in the first manner to damage generated in the second manner.

A game processing method of an eleventh aspect is a process executed by a computer, the process including, in a game in which it is possible that a user ascertains a result of a fight, performing the fight in a first manner in a case in which a user is unable to ascertain a course of the fight, and performing the fight in a second manner and with all or part of the first manner in a case in which a user is able to ascertain the course of the fight.

A game device of a twelfth aspect includes a control section that, in a game in which it is possible that a user ascertains a result of a fight, performs the fight in a first manner in a case in which a user is unable to ascertain a course of the fight, and performs the fight in a second manner and with all or part of the first manner in a case in which a user is able to ascertain the course of the fight.

The program product including a game program, the game processing method, and the game device according to the present disclosure are able to reduce a gap between a fight result as expected by a user and an actual fight result, compared to a configuration in which a fight is not performed with a combination of plural methods.

What is claimed is:

1. A non-transitory recording medium storing a game program that is executable by a computer to perform a process, the process comprising
in a computer game in which it is possible that a user ascertains a result of a fight:
performing the fight in a first manner in a case in which the user is unable to ascertain a course of the fight; and
performing the fight in a second manner and with all or part of the first manner, in a case in which the user is able to ascertain the course of the fight.

2. The non-transitory recording medium of claim 1, wherein:
the first manner is a manner that reduces a first parameter;
the second manner is a manner that reduces a second parameter; and
the process includes, when reducing the second parameter, increasing a reduction amount of the second parameter based on the first parameter and the second parameter.

3. The non-transitory recording medium of claim 1, wherein:
the first manner is a manner to periodically reduce a first parameter; and
the second manner is a manner to irregularly reduce a second parameter.

4. The non-transitory recording medium of claim 2, wherein:
the first parameter is a parameter that is set for a specific group that is a group of a plurality of game objects;
the second parameter is a parameter that is set for a specific object contained in the plurality of game objects; and
the process includes:
when reducing the second parameter, in a case in which the second parameter is greater than a third parameter resulting from dividing the first parameter by a number of the plurality of game objects, adding a difference between the second parameter and the third parameter to the reduction amount of the second parameter to be reduced in the second manner.

5. The non-transitory recording medium of claim 4, wherein:
a normal object, and a special object for which the second parameter is greater than that of the normal object, are provided as specific objects; and
the process includes:
when performing the fight in the first manner, acquiring the first parameter, and a special parameter of the special object which is different from the second parameter, and allocating a reduction amount of a parameter by the first manner across a deduction from the first parameter and a deduction from the special parameter;
when reducing the second parameter of the normal object, acquiring the second parameter and the first parameter of the normal object, and in a case in which the second parameter of the normal object is greater than the third parameter of the normal object, adding a difference between the second parameter of the normal object and the third parameter of the normal object to a reduction amount of the second parameter of the normal object to be reduced in the second manner; and
when reducing the second parameter of the special object, acquiring the second parameter and the special parameter of the special object, and in a case in which the second parameter of the special object is greater than the special parameter, adding a difference between the second parameter and the special parameter of the special object to a reduction amount of the second parameter of the special object to be reduced in the second manner.

6. The non-transitory recording medium of claim 2, wherein:
the process includes:
setting a specific upper limit to an increase amount in a case in which at least one of the increase amount, to increase the reduction amount of the second parameter, exceeds a reference value, or a specific object having the second parameter that is to be reduced, is in a specific state.

7. The non-transitory recording medium of claim 4, wherein:
the process includes increasing a possibility that the second parameter of the specific object is reduced in a case in which the second parameter is greater than the third parameter.

8. The non-transitory recording medium of claim 4, wherein:
the process includes:
in a case in which the third parameter is a specific threshold value or lower, reducing a number of the plurality of game objects serving as a divisor in a computation equation of the third parameter computed by dividing the first parameter by the number of the plurality of game objects such that the third parameter exceeds the specific threshold value; and
setting the third parameter newly computed based on the computation equation for some of the specific objects corresponding to the new divisor among all of the specific objects configuring the specific group, and setting a lowest value of the third parameter for a remainder of the specific objects.

9. The non-transitory recording medium of claim 1, wherein:
in the first manner, evidence of damage generated in the fight does not associate with motions of game objects; and
in the second manner evidence of damage generated in the fight associates with the motions of the game objects.

10. The non-transitory recording medium of claim 1, wherein:
the process includes, in a case in which the user is able to ascertain the course of the fight, adding a weighted value of damage generated in the first manner to damage generated in the second manner.

11. The non-transitory recording medium of claim 1, wherein:
a case in which the user is able to ascertain the course of the fight is a case in which motions of game objects are displayed on a display during the fight; and
a case in which the user is unable to ascertain the course of the fight is a case in which the motions of the game objects are not displayed on the display during the fight.

12. The non-transitory recording medium of claim 11, wherein:
the process includes:
displaying the fight in a first area of the display in a case in which the user is able to ascertain the course of the fight; and
displaying the fight in a second area of the display in a case in which the user is unable to ascertain the course of the fight.

13. The non-transitory recording medium of claim 4, wherein:
the process includes:
causing the specific object for which the second parameter has become a lowest value to disappear from being displayed on a display;
in a case in which the user is able to ascertain the course of the fight, continuing to display, on the display, the plurality of game objects configuring the specific group for which the first parameter has become a lowest value, and then causing the specific object which has received damage to disappear from being displayed on the display; and
in a case in which the user is unable to ascertain the course of the fight, causing the plurality of game objects configuring the specific group for which the first parameter has become the lowest value to disappear from being displayed on the display.

14. A game processing method, comprising
in a computer game in which it is possible that a user ascertains a result of a fight,
by a processor:
performing the fight in a first manner in a case in which the user is unable to ascertain a course of the fight; and
performing the fight in a second manner and with all or part of the first manner in a case in which the user is able to ascertain the course of the fight.

15. A game device, comprising:
a memory, and
a processor coupled to the memory, wherein
the processor is configured to:
in a computer game in which it is possible that a user ascertains a result of a fight:
perform the fight in a first manner in a case in which the user is unable to ascertain a course of the fight; and
perform the fight in a second manner and with all or part of the first manner in a case in which the user is able to ascertain the course of the fight.
